(19) United States
(12) Patent Application Publication
(10) Pub. No.: US 2013/0097491 A1
(43) Pub. Date: Apr. 18, 2013

(54) INFORMATION PROCESSING APPARATUS, INFORMATION PROCESSING METHOD, AND COMPUTER READABLE MEDIUM

(71) Applicant: Tomoyuki SHOYA, Kanagawa (JP)

(72) Inventor: Tomoyuki SHOYA, Kanagawa (JP)

(73) Assignee: FUJI XEROX CO., LTD., Tokyo (JP)

(21) Appl. No.: 13/442,295

(22) Filed: Apr. 9, 2012

(30) Foreign Application Priority Data
Oct. 12, 2011 (JP) 2011-224821

(51) Int. Cl. G06F 17/20

(52) U.S. Cl. 715/255

(57) ABSTRACT

An information processing apparatus includes an obtaining unit that obtains information regarding a first meeting, a feature extracting unit that extracts a feature of the first meeting on the basis of the information, a meeting extracting unit that extracts a second meeting on the basis of the feature of the first meeting, the second meeting having been registered, a determining unit that determines whether or not the first meeting is continuous with the second meeting, a registering unit that registers the first meeting and the second meeting as a group of continuous meetings if the determining unit determines that the first meeting is continuous with the second meeting, a document extracting unit that extracts one or more documents associated with the group of the continuous meetings, and a presenting unit that presents a list of the one or more documents on the basis of a determination result.

### CROSS-REFERENCE TO RELATED APPLICATIONS

This application is based on and claims priority under 35 USC 119 from Japanese Patent Application No. 2011-224821 filed Oct. 12, 2011.

### BACKGROUND

(i) Technical Field

The present invention relates to an information processing apparatus, an information processing method, and a computer readable medium.

(ii) Related Art

Technologies related to registration of a document are available.

### SUMMARY

According to an aspect of the invention, there is provided an information processing apparatus including an obtaining unit, a feature extracting unit, a meeting extracting unit, a determining unit, a registering unit, a document extracting unit, and a presenting unit. The obtaining unit obtains information regarding a first meeting. The feature extracting unit extracts a feature of the first meeting on the basis of the information regarding the first meeting. The meeting extracting unit extracts a second meeting on the basis of the feature of the first meeting, the second meeting having been registered. The determining unit determines whether or not the first meeting is continuous with the second meeting. The registering unit registers the first meeting and the second meeting as a group of continuous meetings if the determining unit determines that the first meeting is continuous with the second meeting. The document extracting unit extracts one or more documents associated with the group of the continuous meetings. The presenting unit presents a list of the one or more documents extracted by the document extracting unit on the basis of a determination result by the determining unit.

### BRIEF DESCRIPTION OF THE DRAWINGS

An exemplary embodiment of the present invention will be described in detail based on the following figures, wherein:

FIG. 1 is a conceptual module configuration diagram according to an exemplary embodiment of the present invention;

FIG. 2 is a diagram illustrating an example of a system configuration according to the exemplary embodiment;

FIG. 3 is a flowchart illustrating an example of a process according to the exemplary embodiment;

FIG. 4 is a diagram illustrating an example of the data structure of a schedule information table;

FIG. 5 is a diagram illustrating an example of a schedule presentation screen;

FIG. 6 is a diagram illustrating an example of an associated document registration screen;

FIG. 7 is a diagram illustrating an example of a continuous meeting entity registration screen;

FIG. 8 is a diagram illustrating an example of a list-of-meeting-entities region and so forth;

FIG. 9 is a diagram illustrating an example of a schedule presentation screen;

FIG. 10 is a diagram illustrating an example of an associated document presentation screen;

FIG. 11 is a flowchart illustrating an example of a process according to the exemplary embodiment;

FIG. 12 is a diagram illustrating an example of the data structure of a meeting entity information table;

FIG. 13 is a diagram illustrating an example of the data structure of a meeting-document association management table;

FIG. 14 is a diagram illustrating an example of a list-of-meeting-entities region and a list-of-documents-associated-with-theme-weekly-briefing region;

FIG. 15 is a flowchart illustrating an example of a process according to the exemplary embodiment;

FIG. 16 is a flowchart illustrating an example of a process according to the exemplary embodiment;

FIG. 17 is a diagram illustrating an example of the data structure of a number-of-presentations table;

FIG. 18 is a diagram illustrating an example of a list-of-meeting-entities region and a list-of-documents-associated-with-theme-weekly-briefing region;

FIG. 19 is a flowchart illustrating an example of a process according to the exemplary embodiment;

FIG. 20 is a diagram illustrating an example of a schedule presentation screen;

FIG. 21 is a diagram illustrating an example of an associated document presentation registration screen;

FIG. 22 is a diagram illustrating an example of an associated document presentation registration screen; and

FIG. 23 is a block diagram illustrating an example of the hardware configuration of a computer according to the exemplary embodiment.

### DETAILED DESCRIPTION

Hereinafter, an exemplary embodiment for realizing the present invention will be described with reference to the drawings.

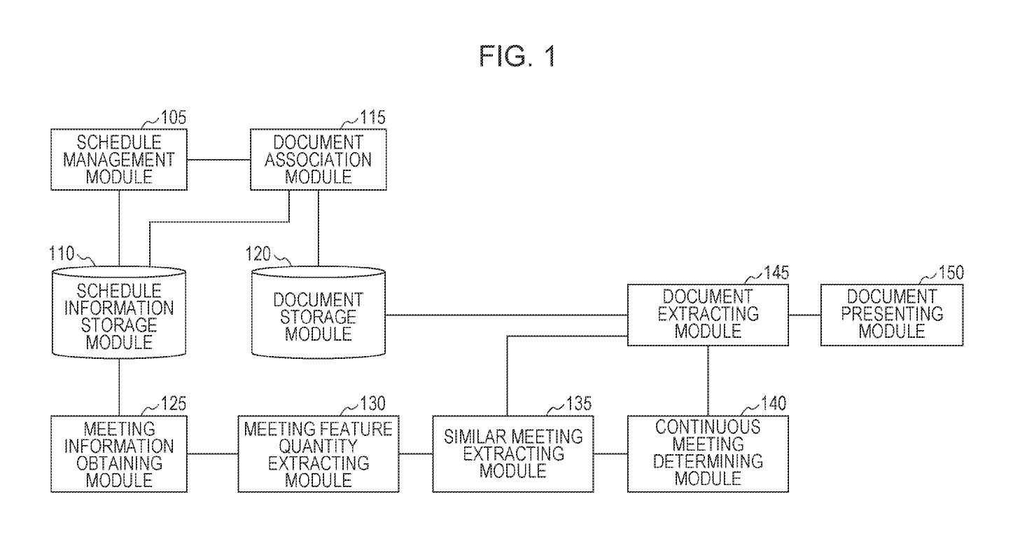

FIG. 1 is a conceptual module configuration diagram illustrating an example configuration according to the exemplary embodiment.

In general, “modules” are components of software (computer program) or hardware that may be logically separated from one another. Thus, the modules according to the exemplary embodiment correspond to not only modules in a computer program but also modules in a hardware configuration. Therefore, the description of the exemplary embodiment includes a description of a computer program for causing a computer to function as those modules (a program for causing a computer to execute individual program steps, a program for causing a computer to function as individual units, or a program for causing a computer to realize individual functions), a system, and a method. For the convenience of description, expressions “store”, “cause . . . to store”, and expressions equivalent thereto will be used. These expressions specifically mean “cause a storage device to store” or “perform control to cause a storage device to store” in the case of a computer program. The modules may correspond to functions in a one-to-one relationship. In terms of packaging, a single module may be constituted by a single program, plural modules may be constituted by a single program, or a single module may be constituted by plural programs. Also, plural modules may be executed by a single computer, or a single module may be executed by plural computers in a distributed or parallel environment. Alternatively, a single module may include another module. Hereinafter, “connection” is used to refer to a logical connection (transmission and reception of data, an instruction, a reference relationship between pieces of data, etc.), as well as a physical connection. “Predetermined” means being determined before a certain operation, and includes the meaning of being determined in accordance with a present situation/state or in accordance with a previous situation/state before a certain operation after processing according to the exemplary embodiment starts, as well as before processing according to the exemplary embodiment starts. A description having the meaning “in the case of A, B is performed” is used as the meaning “whether A or not is determined, and B is performed if it is determined A”, except for a case where determination of whether A or not is unnecessary.

A system or apparatus may be realized by plural computers, hardware units, devices, or the like connected to one another via a communication medium, such as a network (including communication connections having a one-to-one correspondence), or may be realized by a single computer, hardware unit, device, or the like. “Apparatus” and “system” are used synonymously. Of course, “system” does not include a man-made social “organization” (social system).

Also, target information is read from a storage device in individual processing operations performed by respective modules or in individual processing operations performed by a single module. After each processing operation has ended, the processing result thereof is written into the storage device. Thus, a description of reading from the storage device before a processing operation and writing into the storage device after a processing operation may be omitted. Here, examples of the storage device include a hard disk, a random access memory (RAM), an external storage medium, a storage device connected through a communication line, a register in a central processing unit (CPU), and the like.

An information processing apparatus according to the exemplary embodiment presents a document associated with a meeting, and includes, as illustrated in FIG. 1, a schedule management module 105, a schedule information storage module 110, a document association module 115, a document storage module 120, a meeting information obtaining module 125, a meeting feature quantity extracting module 130, a similar meeting extracting module 135, a continuous meeting determining module 140, a document extracting module 145, and a document presenting module 150.

The schedule management module 105 is connected to the schedule information storage module 110 and the document association module 115. The schedule management module 105 manages a schedule item, which includes information about a meeting stored in the schedule information storage module 110. Here, “management” includes causing the schedule information storage module 110 to store a schedule item used as a schedule of individual operators, presenting the schedule item on a display of a terminal apparatus of an operator, and modifying the schedule item, in accordance with an operation performed by the operator. The schedule management module 105 may have a function of reminding an operator of the start of a meeting indicated in a schedule item at a time point a predetermined time before a starting time set in the schedule item.

Here, a “meeting” is a gathering of multiple people that is held to perform discussion, consultation, reporting, decision making, and the like. Typically, a meeting is held in a single place, such as a meeting room. A meeting may be held in such a manner that individual participants are in remote places, such as in an electronic meeting.

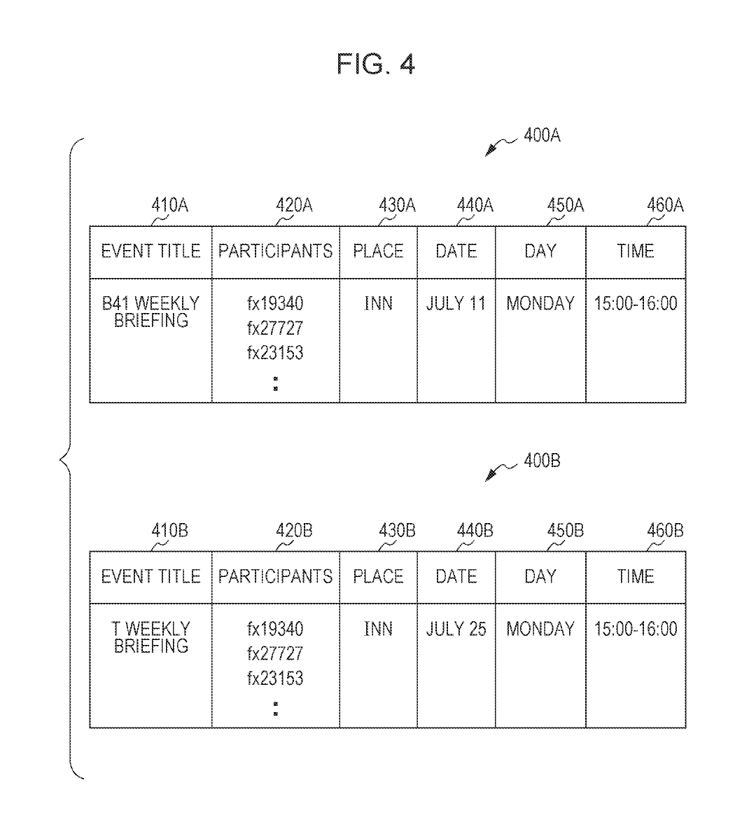

The schedule information storage module 110 is connected to the schedule management module 105, the document association module 115, and the meeting information obtaining module 125. The schedule information storage module 110 is accessed by the schedule management module 105, the document association module 115, and the meeting information obtaining module 125, and stores the above-described schedule item. The schedule item, which is information about a meeting stored in the schedule information storage module 110, may be a schedule information table 400 illustrated in FIG. 4, for example, which will be described below.

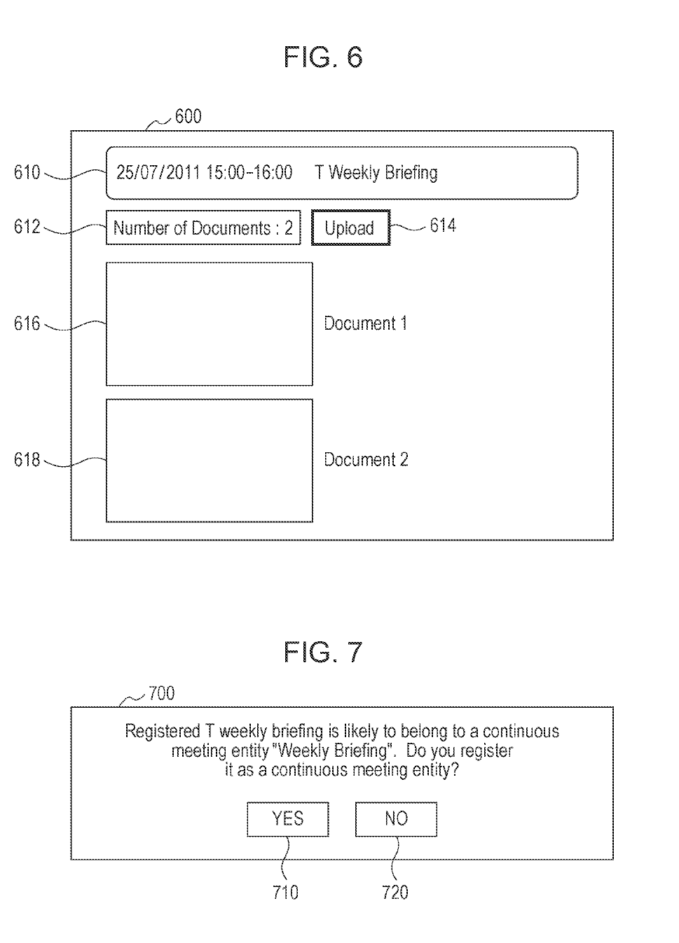

The document association module 115 is connected to the schedule management module 105, the schedule information storage module 110, and the document storage module 120. The document association module 115 associates a document (electronic document) with a meeting indicated in a schedule item. Examples of a document associated with a meeting include presentation materials used in the meeting, minutes, and the like. The document may include still image data, moving image data, or audio data, as well as text data. Here, “association” includes creating a data state in which a document associated with a meeting is presented when the schedule item of the meeting is presented. For example, a link to a document may be provided as an attribute of a schedule item of a meeting. The document to be associated with a meeting may be specified in accordance with an operation performed by an operator. This will be described below with reference to FIG. 6.

The document storage module 120 is connected to the document association module 115 and the document extracting module 145. The document storage module 120 is accessed by the document association module 115 and the document extracting module 145, and stores the above-described document.

The meeting information obtaining module 125 is connected to the schedule information storage module 110 and the meeting feature quantity extracting module 130. The meeting information obtaining module 125 obtains information about a meeting. Specifically, the meeting information obtaining module 125 obtains information about a meeting from a schedule item stored in the schedule information storage module 110. For example, the meeting information obtaining module 125 may select a schedule item in which a type as an attribute indicates a meeting.

The meeting feature quantity extracting module 130 is connected to the meeting information obtaining module 125 and the similar meeting extracting module 135. The meeting feature quantity extracting module 130 extracts a feature of a meeting on the basis of information about the meeting obtained by the meeting information obtaining module 125. For example, the meeting feature quantity extracting module 130 may construct a feature space in which each item included in information about a meeting serves as an axis, and generate a vector using the information about the meeting in the feature space.

The similar meeting extracting module 135 is connected to the meeting feature quantity extracting module 130, the continuous meeting determining module 140, and the document extracting module 145. The similar meeting extracting module 135 extracts a meeting similar to a target meeting on the basis of the feature of the target meeting extracted by the meeting feature quantity extracting module 130. The similar meeting extracting module 135 may determine that a meeting is similar to a target meeting when the distance between vectors in the foregoing feature space is equal to or smaller than a predetermined value, for example. In this case, Karhunen-Loeve (KL) expansion, linear discrimination, or the like may be used.

The continuous meeting determining module 140 is connected to the similar meeting extracting module 135 and the document extracting module 145. The continuous meeting determining module 140 determines whether or not a target meeting is continuous with a meeting extracted by the similar meeting extracting module 135. If the target meeting is a continuous meeting, the continuous meeting determining module 140 registers the target meeting as a member of a group of continuous meetings. The continuous meeting determining module 140 may determine that a target meeting is a continuous meeting when the distance between vectors in the foregoing feature space is equal to or smaller than a predetermined value (a value smaller than the value used by the similar meeting extracting module 135), for example. Alternatively, the continuous meeting determining module 140 may determine whether or not different character strings (character strings of one or more characters) in the character strings of meeting titles (one of attributes of a schedule item) are continuous with each other. Specifically, in the case of “the first X meeting” and “the second X meeting”, different character strings are “first” and “second”. These character strings are continuous with each other, and thus these two meetings are determined to be continuous with each other. Here, continuous character strings have continuous character codes, or have a predetermined relationship between character strings compared with each other (for example, “first” and “second” are continuous with each other, and “first half” and “latter half” are continuous with each other). Alternatively, a condition may be defined in which a character string to be compared is positioned within a predetermined number of characters from the first or last character of a meeting title.

The document extracting module 145 is connected to the document storage module 120, the similar meeting extracting module 135, the continuous meeting determining module 140, and the document presenting module 150. The document extracting module 145 extracts a document associated with a meeting extracted by the similar meeting extracting module 135. Specifically, the document extracting module 145 may extract a document title, a thumbnail image of a document, or the like by following a link to the document, which is an attribute of a schedule item of the meeting.

The document presenting module 150 is connected to the document extracting module 145. The document presenting module 150 presents a list of one or more documents extracted by the document extracting module 145, on the basis of a determination result generated by the continuous meeting determining module 140. The list presented here may include document titles, thumbnails of documents, creators of documents, dates and times of creation of documents, etc.

The document presenting module 150 may determine a presentation order of documents in the list on the basis of the number of times each document is associated with a meeting.

Alternatively, the document presenting module 150 may determine the presentation order of documents in the list on the basis of the number of operations performed on each document. For example, the operations counted here are operations performed by an operator, and include selecting a document from the list, presenting the document, printing the document, editing the document, and the like.

Also, the document presenting module 150 may extract a starting time of a meeting from the schedule information storage module 110, which stores at least the starting time of the meeting, compare the extracted starting time with the current time, and determine whether or not the document extracted by the document extracting module 145 is to be presented. A starting time of a meeting is one of the attributes of a schedule item stored in the schedule information storage module 110. After the starting time, or when the starting time is approaching, the document presenting module 150 presents a list of documents associated with a similar meeting extracted by the similar meeting extracting module 135. In other cases, the document presenting module 150 presents only the documents associated with the meeting. Also, a count result may be stored in association with the documents.

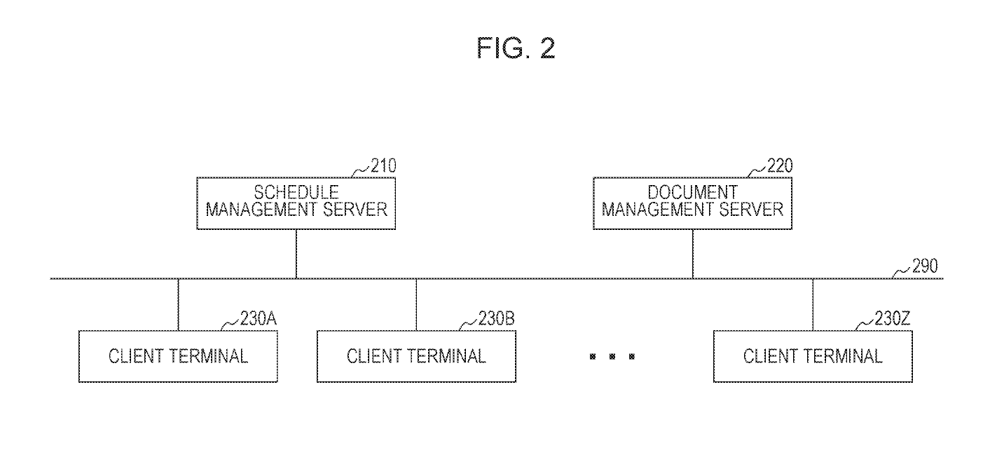

FIG. 2 is a diagram illustrating an example of a system configuration according to the exemplary embodiment. A schedule management server 210, a document management server 220, a client terminal 230A, a client terminal 230B, and a client terminal 230Z are connected to one another via a communication line 290. The schedule management server 210 includes the schedule management module 105, the schedule information storage module 110, and the document association module 115 in FIG. 1. The document management server 220 includes the document storage module 120. Each client terminal 230 includes the meeting information obtaining module 125, the meeting feature quantity extracting module 130, the similar meeting extracting module 135, the continuous meting determining module 140, the document extracting module 145, and the document presenting module 150. The communication line 290 may be a wireless or wired communication medium, for example, the Internet or an intranet.

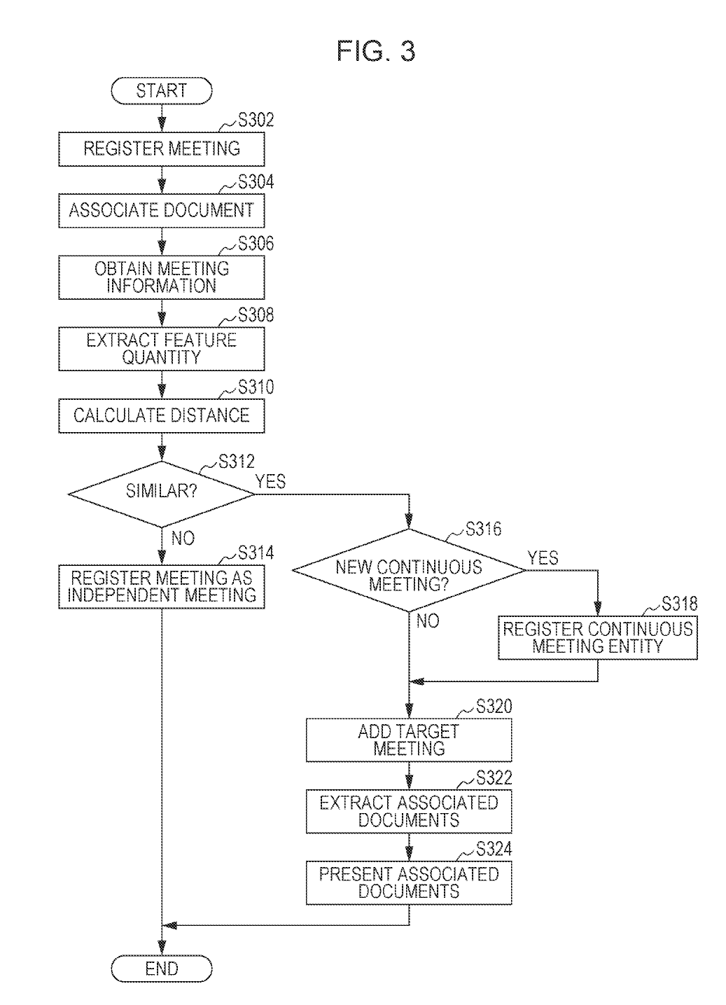

FIG. 3 is a flowchart illustrating an example of a process according to the exemplary embodiment.

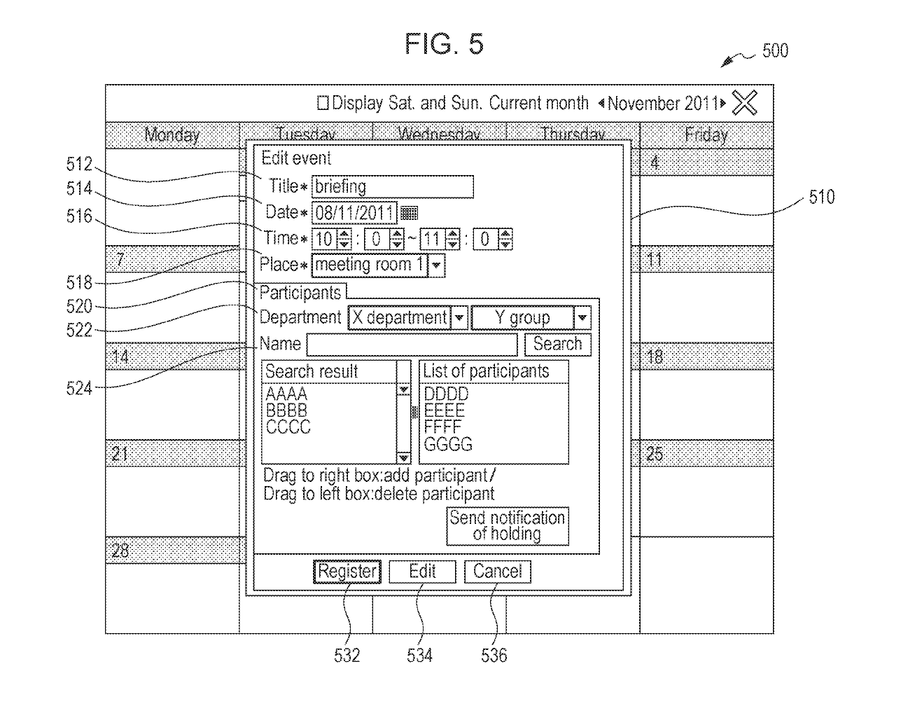

In step S302, the schedule management module 105 displays a screen, and newly registers a meeting in accordance with an operation performed on the display by an operator. The schedule management module 105 presents, for example, a schedule presentation screen 500. FIG. 5 is a diagram illustrating an example of the schedule presentation screen 500.

The schedule management module 105 presents the schedule presentation screen 500 on a display of the client terminal 230. The schedule management module 105 presents a title field 512, a date field 514, a time field 516, and a place field 518 in a schedule registration section 510, and also presents a department field 522 and a name field 524 in a participant setting region 520. Information is set in the individual fields in accordance with an operation performed by an operator.

Also, the schedule management module 105 presents a register button 532, an edit button 534, and a cancel button 536 in the schedule registration section 510. Upon any one of these buttons being selected by the operator, the schedule management module 105 performs the process corresponding to the button. For example, upon the register button 532 being selected, the schedule management module 105 causes the schedule information storage module 110 to store the content in the title field 512, the date field 514, the time field 516, the place field 518, the department field 522, and the name field 524.

Accordingly, a schedule item of a meeting is stored in the schedule information storage module 110. An example of the schedule item of the meeting is the schedule information table 400. FIG. 4 is a diagram illustrating an example of the data structure of the schedule information table 400. A schedule information table 400A has an event title column 410A, a participant column 420A, a place column 430A, a date column 440A, a day column 450A, and a time column 460A. The event title column 410A stores a title of a meeting. The participant column 420A stores participant identification information for uniquely identifying participants of the meeting. The place column 430A stores the name of a place where the meeting is held. The date column 440A stores the date when the meeting is held. The day column 450A stores the day of the date. The time column 460A stores the time (starting time and end time) when the meeting is held.

Also, a schedule information table 400B, which is equivalent to the schedule information table 400A, is created for another meeting, and is stored in the schedule information storage module 110.

In step S304, the document association module 115 displays a screen, and associates a document with the registered meeting in accordance with an operation performed on the display by the operator. The document association module 115 presents, for example, an associated document registration screen 600. FIG. 6 is a diagram illustrating an example of the associated document registration screen 600.

The document association module 115 presents, in the associated document registration screen 600, a schedule information presentation region 610, a number-of-associated-documents presentation region 612, an upload button 614, a document thumbnail presentation region 616, and a document thumbnail presentation region 618.

Information about the meeting with which a document is associated (for example, a date, a time, an event title, etc.) is extracted from the schedule information storage module 110, and is presented in the schedule information presentation region 610. The number of documents associated with the meeting is presented in the number-of-associated-documents presentation region 612. A thumbnail of the first page of a document associated with the meeting is presented in each of the document thumbnail presentation regions 616 and 618.

Upon the upload button 614 being selected by a selection operation performed by the operator, the document association module 115 presents a search screen, and associates a document selected through searching performed in accordance with a search operation by the operator with the meeting.

In step S306, the meeting information obtaining module 125 obtains meeting information. For example, the meeting information obtaining module 125 may obtain a schedule item in which a type as an attribute indicates a meeting.

In step S308, the meeting feature quantity extracting module 130 generates a vector from the meeting information and extracts a feature quantity. For example, the meeting feature quantity extracting module 130 selects items in the schedule information table 400 (for example, the event title column 410, participant column 420, place column 430, day column 450, and time column 460), and generates a vector in which the items serve as axes. Here, extracting a feature corresponds to selecting items in the schedule information table 400 and generating a vector. In the case of text information, such as in the event title column 410, morphological analysis may be performed on the text information, and a vector may be generated by using morphemes.

In step S310, the similar meeting extracting module 135 calculates the distance between the vector of the target meeting (newly registered meeting) and the vector of an existing meeting.

In step S312, the similar meeting extracting module 135 determines whether or not the target meeting is similar to the existing meeting. If the calculated distance is equal to or less than a predetermined distance, the similar meeting extracting module 135 determines that the target meeting is similar to the existing meeting, and the process proceeds to step S316. Otherwise, the process proceeds to step S314.

In step S314, the similar meeting extracting module 135 registers the target meeting as an independent meeting (a meeting having no similar meeting).

In step S316, the continuous meeting determining module 140 determines whether or not the target meeting is a new meeting (whether or not the target meeting is continuous with an existing meeting). If the target meeting is a new meeting, the process proceeds to step S318. Otherwise, the process proceeds to step S320. Whether or not the target meeting is a continuous meeting is determined by the continuous meeting determining module 140.

In step S318, the continuous meeting determining module 140 newly creates a continuous meeting entity. That is, the continuous meeting determining module 140 generates identification information of the continuous meeting entity (meeting entity ID), and newly registers the continuous meeting entity.

In step S320, the continuous meeting determining module 140 adds the target meeting to the continuous meeting entity. When step S320 is performed after step S318, the continuous meeting determining module 140 assigns the meeting entity ID newly generated in step S318 to the target meeting. When step S320 is performed after step S316, the continuous meeting determining module 140 assigns, to the target meeting, the ID of the meeting entity to which a meeting similar to the target meeting belongs. Here, assigning a meeting entity ID specifically means adding the meeting entity ID as a schedule item stored in the schedule information storage module 110.

Here, the continuous meeting determining module 140 may present, for example, a continuous meeting entity registration screen 700, thereby causing an operator to perform determination. FIG. 7 is a diagram illustrating an example of the continuous meeting entity registration screen 700.

The continuous meeting determining module 140 may present the continuous meeting entity registration screen 700 on the display, for example.

A message “Registered T weekly briefing is likely to belong to a continuous meeting entity “Weekly Briefing”. Do you register it as a continuous meeting entity?”, an YES button 710, and a NO button 720 are displayed on the continuous meeting entity registration screen 700. Upon the YES button 710 being selected by a selection operation by the operator, the meeting “T weekly briefing” is registered as a member of the meeting entity “weekly briefing” in the schedule information storage module 110. Specifically, the meeting entity ID of “weekly briefing” is assigned to “T weekly briefing”. After that, the name of the meeting entity may be set by an operation performed by the operator.

In step S322, the document extracting module 145 extracts one or more documents associated with the similar meeting.

In step S324, the document presenting module 150 presents a list of one or more documents associated with the continuous meeting. Upon one of the documents being selected, the document presenting module 150 presents the selected document.

An example of presenting the relationship among the meeting entity generated in this way, meetings, and documents associated with the meetings will be described.

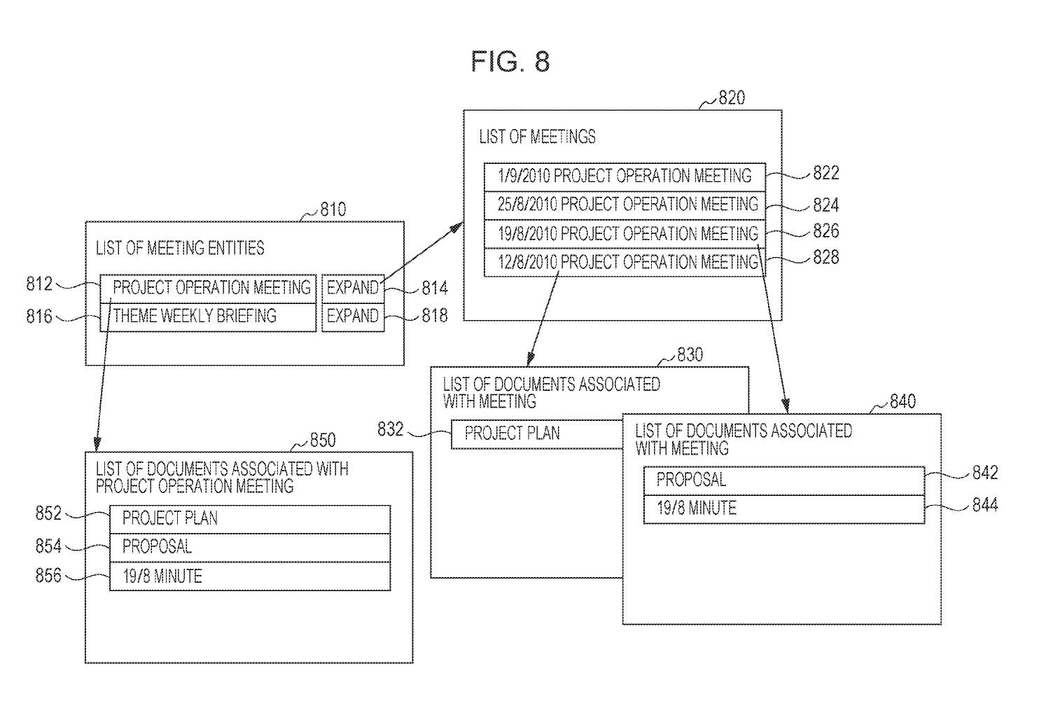

FIG. 8 is a diagram illustrating an example of a list-of-meeting-entities region 810 and so forth.

A set of a project operation meeting 812 and expand 814, and a set of a theme weekly briefing 814 and expand 818 are presented in the list-of-meeting-entities region 810. Here, meeting entities having a meeting entity ID are presented. The name of each meeting entity may be set by an operation performed by an operator. Alternatively, the title of a meeting registered first in the meeting entity (event title) may be used.

In a list-of-meetings region 820, a Jan. 9, 2010 project operation meeting 822, a 25/8/2010 project operation meeting 824, a 19/8/2010 project operation meeting 826, and a Dec. 8, 2010 project operation meeting 828 are presented. A list of meetings belonging to the meeting entity is presented. In other words, a group of meetings having the same meeting entity ID is presented.

A project plan 832 is presented in a list-of-documents-associated-with-meeting region 830. A list of one or more documents associated with the meeting is presented.

A proposal 842 and a 19/8 minute 844 are presented in a list-of-documents-associated-with-meeting region 840. A list of one or more documents associated with the meeting is presented.

A project plan 852, a proposal 854, and a 19/8 minute 856 are presented in a list-of-documents-associated-with-project-operation-meeting region 850. A list of one or more documents associated with the meetings belonging to the project operation meeting 812 is presented. Specifically, the meetings belonging to the project operation meeting 812 are the Jan. 9, 2010 project operation meeting 822, the 25/8/2010 project operation meeting 824, the 19/8/2010 project operation meeting 826, and the Dec. 8, 2010 project operation meeting 828 in the list-of-meetings region 820. The project plan 852 (the project plan 832 associated with the Dec. 8, 2010 project operation meeting 828), the proposal 854, and the 19/8 minute 856 (the proposal 842 and the 19/8 minute 844 associated with the 19/8/2010 project operation meeting 826), which are the documents associated with these meetings, are presented.

Upon the expand 814 in the list-of-meeting-entities region 810 being selected by a selection operation performed by the operator, the list-of-meetings region 820 is presented. Upon the project operation meeting 812 in the list-of-meeting-entities region 810 being selected by a selection operation performed by the operator, the list-of-documents-associated-with-project-operation-meeting region 850 is presented. Upon the 19/8/2010 project operation meeting 826 in the list-of-meetings region 820 being selected by a selection operation performed by the operator, the list-of-documents-associated-with-meeting region 840 is presented. Upon the Dec. 8, 2010 project operation meeting 828 in the list-of-meetings region 820 being selected by a selection operation performed by the operator, the list-of-documents-associated-with-meeting region 830 is presented.

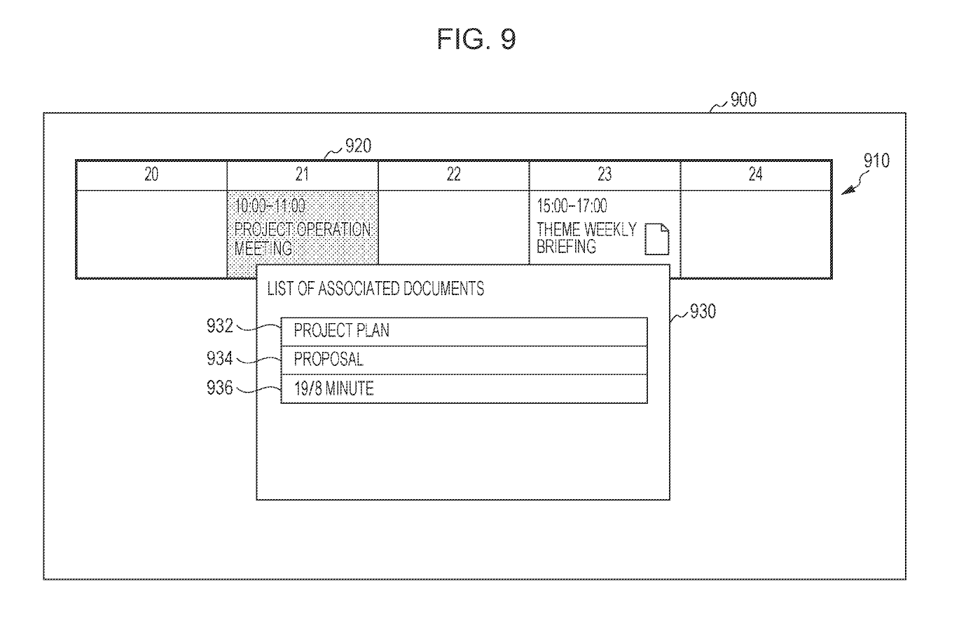

In the case of presenting a schedule item stored in the schedule information storage module 110, the schedule management module 105 may cause step S306 and the steps subsequent thereto illustrated in FIG. 3 to be performed, and may present a list-of-associated-documents region 930 upon a meeting being selected. FIG. 9 is a diagram illustrating an example of a schedule presentation screen 900.

In the schedule presentation screen 900, a schedule presentation region 910 and the list-of-associated-documents region 930 are presented. Upon a meeting in the schedule presentation region 910 being selected, the list-of-associated-documents region 930 is presented. In the list-of-associated-documents region 930, a project plan 932, a proposal 934, and a 19/8 minute 936 are presented. In this case, a list of documents associated with a meeting similar to the meeting “project operation meeting” is presented by performing the above-described process.

The document presenting module 150 may present the documents associated with the similar meeting in the manner illustrated in an associated document presentation screen 1000.

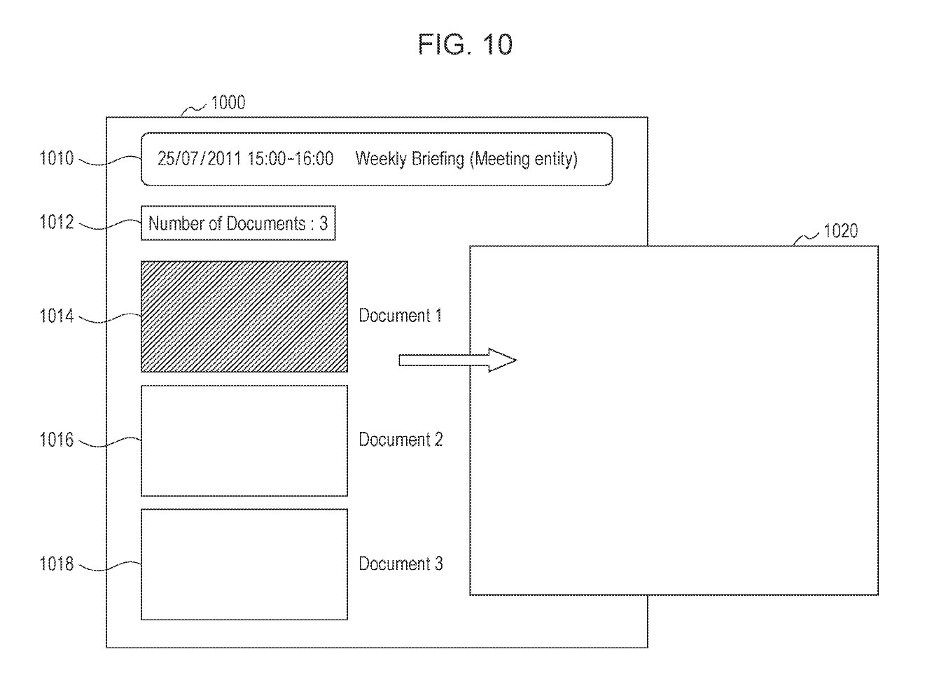

FIG. 10 is a diagram illustrating an example of the associated document presentation screen 1000. In the associated document presentation screen 1000, a schedule information presentation region 1010, a number-of-associated-documents presentation field 1012, a document thumbnail presentation region 1014, a document thumbnail presentation region 1016, and a document thumbnail presentation region 1018 are presented.

Information about the meeting with which a document is associated (for example, a date, a time, and a name of a meeting entity) is extracted from the schedule information storage module 110, and is presented in the schedule information presentation region 1010. The number of documents associated with the meeting entity (the total number of documents associated with the meetings constituting the meeting entity) is presented in the number-of-associated-documents presentation field 1012. A thumbnail of the first page of a document associated with the meeting entity is presented in each of the document thumbnail presentation regions 1014, 1016, and 1018.

Upon the document thumbnail presentation region 1014 being selected by a selection operation performed by the operator, a document presentation region 1020 is presented, and the content of the selected document is presented therein.

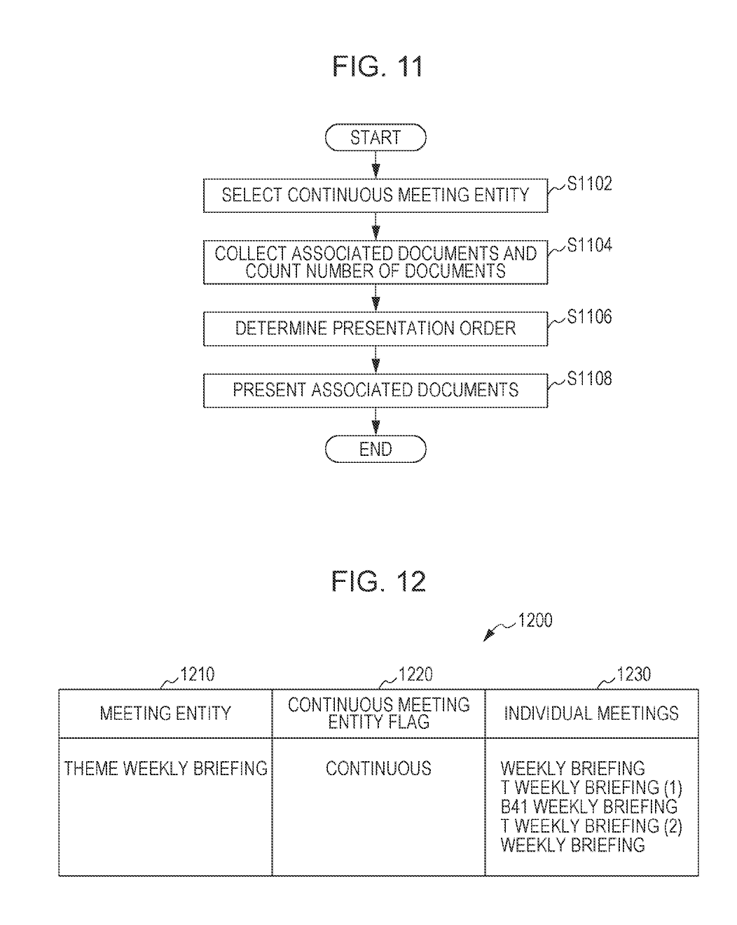

FIG. 11 is a flowchart illustrating an example of a process according to the exemplary embodiment. This flowchart illustrates an example of a process about the order of presentation performed by the document presenting module 150.

FIG. 12 is a diagram illustrating an example of the data structure of a meeting entity information table 1200. The meeting entity information table 1200 is stored in the schedule information storage module 110. The meeting entity information table 1200 has a meeting entity column 1210, a continuous meeting entity flag column 1220, and an individual meetings column 1230. The meeting entity column 1210 stores the name of a meeting entity. The continuous meeting entity flag column 1220 stores a flag indicating whether or not the meeting entity is continuous. The individual meetings column 1230 stores the meetings belonging to the meeting entity.

The meeting entity information table 1200 is generated in step S320 in the flowchart illustrated in FIG. 3.

The document presenting module 150 performs the process illustrated in the flowchart in FIG. 11 with reference to the meeting entity information table 1200.

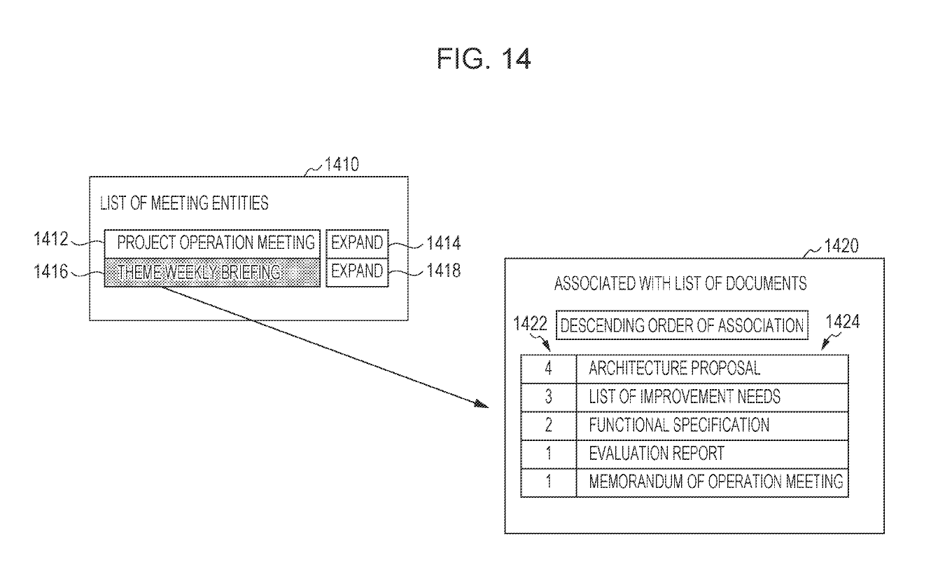

In step S1102, the schedule management module 105 displays a screen, and selects a continuous meeting entity in accordance with an operation performed on the display by an operator. For example, the schedule management module 105 presents a list-of-meeting-entities region 1410. FIG. 14 is a diagram illustrating an example of the list-of-meeting-entities region 1410 and a list-of-documents-associated-with-theme-weekly-briefing region 1420. A set of a project operation meeting 1412 and expand 1414 and a set of a theme weekly briefing 1416 and expand 1418 are presented in the list-of-meeting-entities region 1410. For example, the theme weekly briefing 1416 in the list-of-meeting-entities region 1410 is selected by a selection operation performed by the operator.

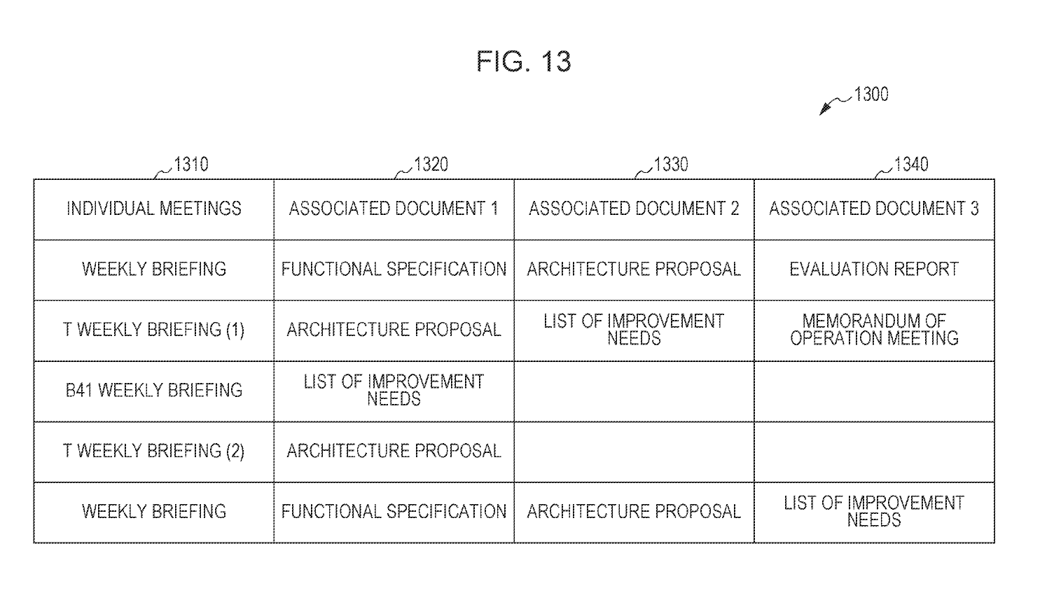

In step S1104, the document presenting module 150 collects the documents associated with the meetings constituting the meeting entity, and counts the number of documents associated in units of document IDs. Here, the document presenting module 150 extracts a group of meetings (individual meetings column 1230) corresponding to the meeting entity (meeting entity column 1210) selected from the above-described meeting entity information table 1200. Then, the document presenting module 150 extracts the documents associated with the meetings. As a result of the extraction, the document presenting module 150 generates a meeting-document association management table 1300. FIG. 13 is a diagram illustrating an example of the data structure of the meeting-document association management table 1300. The meeting-document association management table 1300 has an individual meetings column 1310, an associated document 1 column 1320, an associated document 2 column 1330, and an associated document 3 column 1340. The individual meetings column 1310 stores the titles of meetings. The associated document columns 1320, 1330, and 1340 store the documents associated with the respective meetings. For example, it may be seen that the document “architecture proposal” is associated with four meetings.

In step S1106, the document presenting module 150 determines a presentation order of the documents, that is, sorts the documents in descending order of the number of associations.

In step S1108, the document presenting module 150 presents a list of the associated documents. In the above-described example, upon the theme weekly briefing 1416 in the list-of-meeting-entities region 1410 being selected by a selection operation performed by the operator, the list-of-documents-associated-with-theme-weekly-briefing region 1420 is presented. In the list-of-documents-associated-with-theme-weekly-briefing region 1420, a set of a number-of-associations presentation column 1422 and a document name presentation column 1424 is presented.

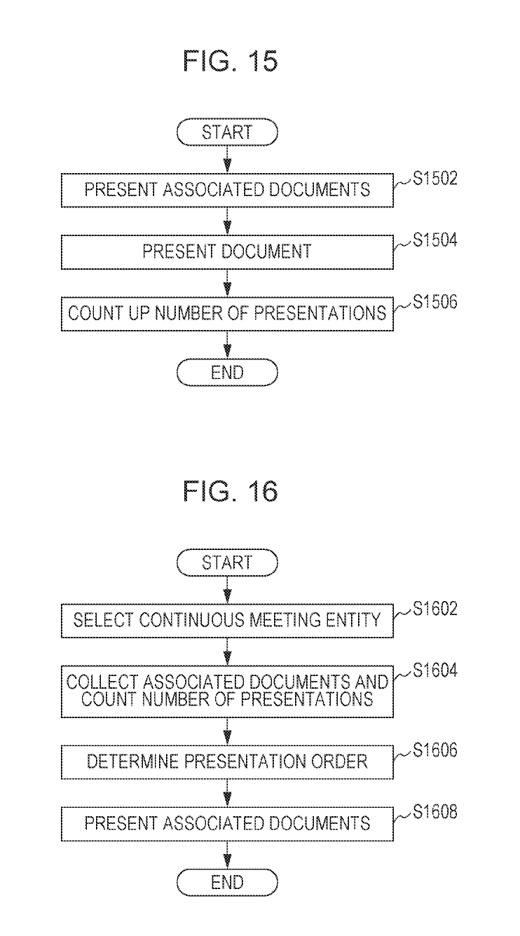

FIGS. 15 and 16 are flowcharts illustrating an example of processes according to the exemplary embodiment. These flowcharts illustrate an example of processes about the order of presentation performed by the document presenting module 150.

In step S1502, the schedule management module 105 displays a screen, selects a meeting or a meeting entity in accordance with an operation performed on the display by an operator. Then, the document presenting module 150 presents a list of associated documents.

In step S1504, the document presenting module 150 selects a document from the list of documents and presents the selected document.

Here, presenting a document means selecting the document thumbnail presentation region 1014 illustrated in FIG. 10 and presenting a document in the document presentation region 1020. Presenting a document does not include presenting a thumbnail in the document thumbnail presentation region 1014. In the exemplary embodiment, the number of times a document has been presented is used. Alternatively, the number of times a document has been downloaded or the number of times a document has been printed may be used.

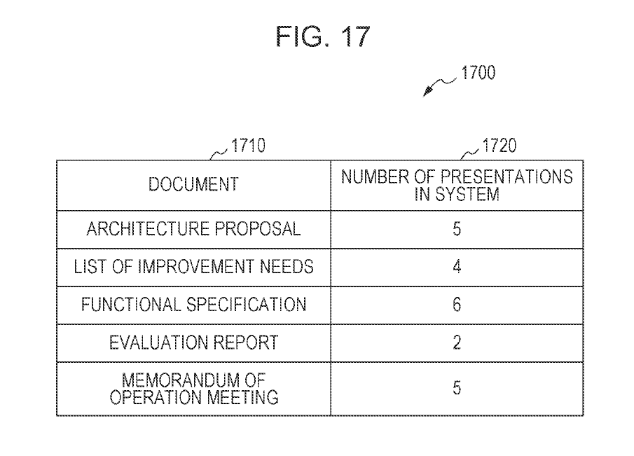

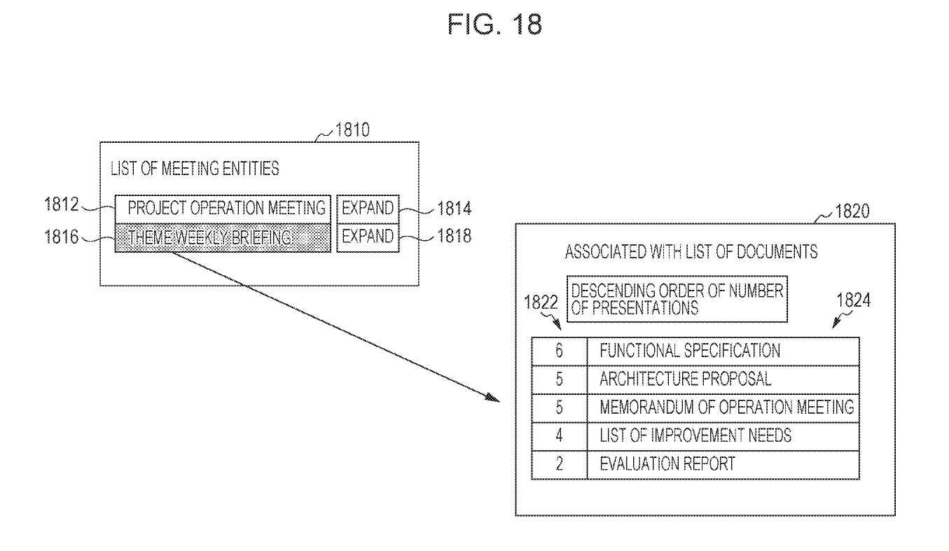

In step S1506, the document presenting module 150 counts up the value for the document in a counter, which stores the number of times each document has been presented. For example, the document presenting module 150 generates a number-of-presentations table 1700. FIG. 17 is a diagram illustrating an example of the data structure of the number-of-presentations table 1700. The number-of-presentations table 1700 has a document column 1710 and a number-of-presentations column 1720. The document column 1710 stores the documents that have been presented. The number-of-presentations column 1720 stores the numbers of times the individual documents have been presented.

In step S1602, the schedule management module 105 displays a screen, and selects a continuous meeting entity in accordance with an operation performed on the display by an operator. For example, the schedule management module 105 presents a list-of-meeting-entities region 1810. FIG. 18 is a diagram illustrating an example of the list-of-meeting-entities region 1810 and a list-of-documents-associated-with-theme-weekly-briefing region 1820. A set of a project operation meeting 1812 and expand 1814 and a set of a theme weekly briefing 1816 and expand 1818 are presented in the list-of-meeting-entities region 1810. For example, the theme weekly briefing 1816 in the list-of-meeting-entities region 1810 is selected by a selection operation performed by the operator.

In step S1604, the document presenting module 150 collects the documents associated with the meetings constituting the meeting entity, and extracts the number of times the documents have been presented in units of document IDs. Here, the document presenting module 150 extracts a group of meetings (individual meetings column 1230) corresponding to the meeting entity (meeting entity column 1210) selected from the above-described meeting entity information table 1200. Then, the document presenting module 150 extracts the documents associated with the meetings. As a result of the extraction, the document presenting module 150 generates the meeting-document association management table 1300. The document presenting module 150 extracts the numbers of times the documents in the associated document columns 1320, 1330, and 1340 have been presented, by using the above-described number-of-presentations table 1700. For example, the number of times the document “functional specification” has been presented is six.

In step S1606, the document presenting module 150 determines a presentation order of the documents, that is, sorts the documents in descending order of the number of presentations.

In step S1608, the document presenting module 150 presents a list of the associated documents. In the above-described example, upon the theme weekly briefing 1816 in the list-of-meeting-entities region 1810 being selected by a selection operation performed by the operator, the list-of-documents-associated-with-theme-weekly-briefing region 1820 is presented. In the list-of-documents-associated-with-theme-weekly-briefing region 1820, a set of a number-of-presentations column 1822 and a document title presentation column 1824 is presented.

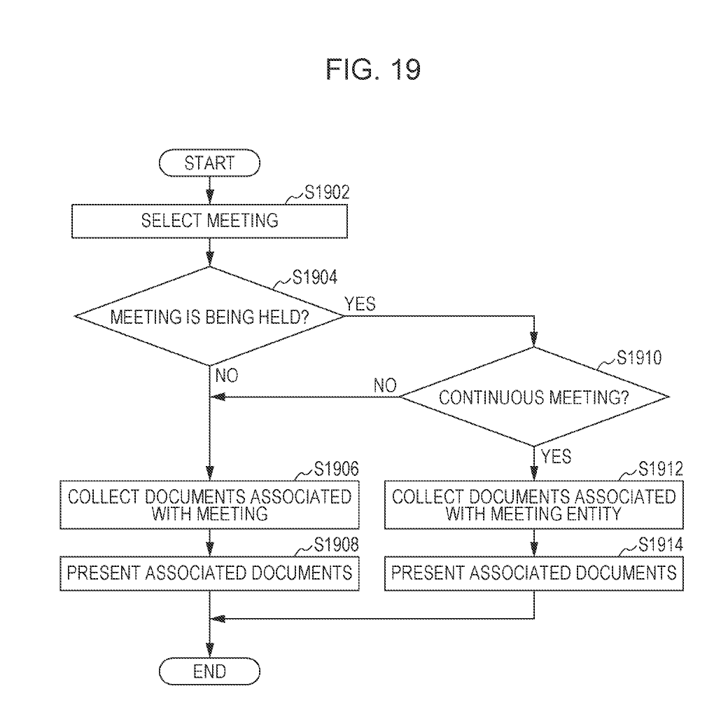

FIG. 19 is a flowchart illustrating an example of a process according to the exemplary embodiment. This flowchart illustrates an example of a process of presenting a list of associated documents in accordance with a starting time of a meeting.

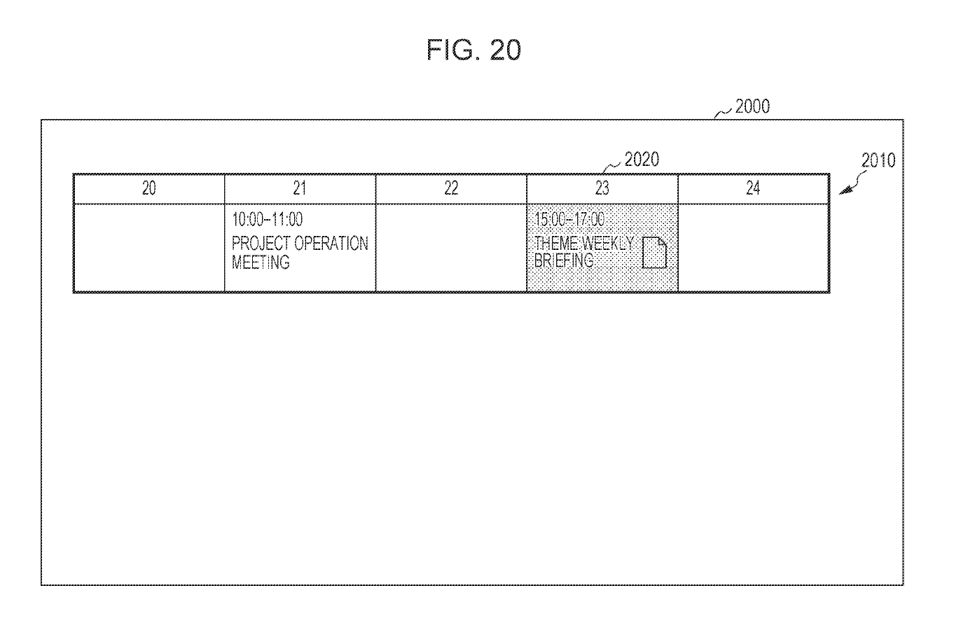

In step S1902, the schedule management module 105 displays a screen, and selects a meeting in accordance with an operation performed on the display by an operator. FIG. 20 is a diagram illustrating an example of a schedule presentation screen 2000. In the schedule presentation screen 2000, a schedule presentation region 2010 is presented. It is assumed that a schedule 2020 has been selected.

In step S1904, the schedule management module 105 determines whether or not the selected meeting is now being held. If the meeting is now being held (the current time is after the starting time of the meeting and before the end time of the meeting), the process proceeds to step S1910. Otherwise, the process proceeds to step S1906.

In step S1906, the document extracting module 145 collects the documents associated with the independent meeting. That is, a list of documents associated with a meeting similar to the meeting is not presented, and a list of documents associated with only the independent meeting is presented.

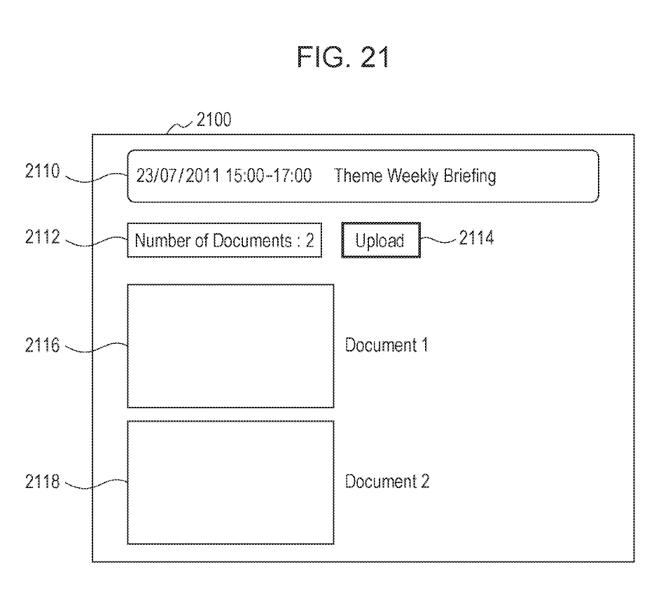

In step S1908, the document presenting module 150 presents the list of documents associated with the selected independent meeting. For example, the document presenting module 150 presents an associated document presentation registration screen 2100. FIG. 21 is a diagram illustrating an example of the associated document presentation registration screen 2100. The document presenting module 150 presents, on the associated document presentation registration screen 2100, a schedule information presentation region 2110, a number-of-associated-documents presentation region 2112, an upload button 2114, a document thumbnail presentation region 2116, and a document thumbnail presentation region 2118. Information about the meeting with which a document is associated (for example, a date, a time, a meeting title, etc.) is extracted from the schedule information storage module 110, and is presented in the schedule information presentation region 2110. The number of documents associated with the meeting is presented in the number-of-associated-documents presentation region 2112. A thumbnail of the first page of a document associated with the meeting is presented in each of the document thumbnail presentation regions 2116 and 2118. Upon the upload button 2114 being selected by a selection operation performed by the operator, a search screen is presented, and a document selected as a result of a search process performed in accordance with a search operation by the operator is associated with the meeting.

In step 1910, the schedule management module 105 determines whether or not there is a meeting continuous with the target meting. If there is a continuous meeting, the process proceeds to step S1912. Otherwise, the process proceeds to step S1906. For example, the schedule management module 105 searches the meeting entity information table 1200, thereby determining whether or not there is a continuous meeting.

In step S1912, the document extracting module 145 collects the documents associated with a continuous meeting entity to which the selected meeting belongs. For example, the document extracting module 145 extracts the documents (in the associated document columns 1320, 1330, and 1340) corresponding to the meetings (in the individual meetings column 1310) from the meeting-document association management table 1300.

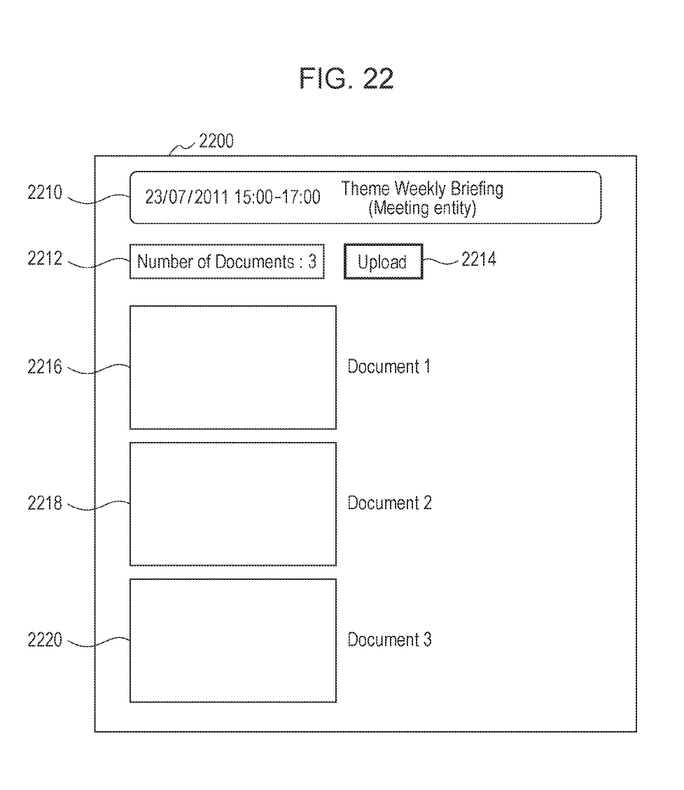

In step S1914, the document presenting module 150 presents a list of documents. For example, the document presenting module 150 presents an associated document presentation registration screen 2200. FIG. 22 is a diagram illustrating an example of the associated document presentation registration screen 2200. The document presenting module 150 presents, on the associated document presentation registration screen 2200, a schedule information presentation region 2210, a number-of-associated-documents presentation region 2212, an upload button 2214, a document thumbnail presentation region 2216, a document thumbnail presentation region 2218, and a document thumbnail presentation region 2220. Information about the meeting entity with which a document is associated (for example, a date, a time, a name of a meeting entity, etc.) is extracted from the schedule information storage module 110, and is presented in the schedule information presentation region 2210. The number of documents associated with the meeting entity (a group of similar meetings) is presented in the number-of-associated-documents presentation region 2212. A thumbnail of the first page of a document associated with the meeting entity is presented in each of the document thumbnail presentation regions 2216, 2218, and 2220. Upon the upload button 2214 being selected by a selection operation performed by the operator, a search screen is presented, and a document selected as a result of a search process performed in accordance with a search operation by the operator is associated with the meeting.

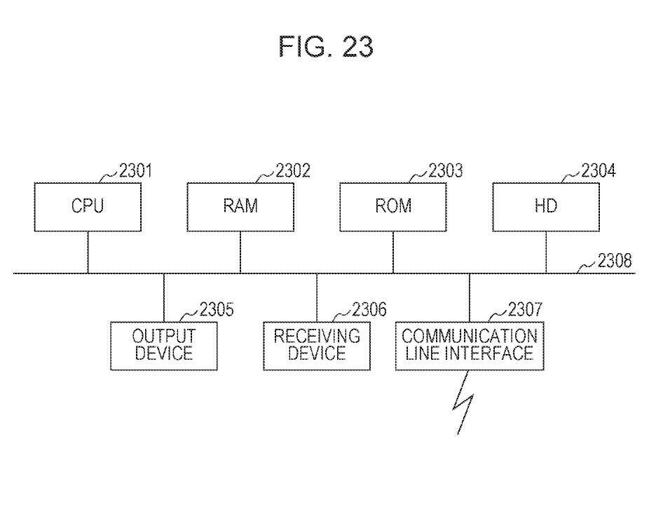

The hardware configuration of a computer that executes a program according to the exemplary embodiment is that of a typical computer, as illustrated in FIG. 23, specifically, a personal computer or a computer serving as a server. That is, a central processing unit (CPU) 2301 is used as a processing unit (operating unit), and a random access memory (RAM) 2302, a read only memory (ROM) 2303, and a hard disk (HD) 2304 are used as a storage device. A hard disk may be used as the HD 2304. The computer illustrated in FIG. 23 includes the CPU 2301, which executes a program corresponding to the schedule management module 105, the document association module 115, the meeting information obtaining module 125, the meeting feature quantity extracting module 130, the similar meeting extracting module 135, the continuous meeting determining module 140, the document extracting module 145, the document presenting module 150, etc.; the RAM 2302 that stores the program and data; the ROM 2303 that stores a program for activating the computer; the HD 2304 serving as an auxiliary storage device; a receiving device 2306 that receives data on the basis of an operation performed on a keyboard, mouse, touch panel, or the like by a user; an output device 2305 such as a cathode ray tube (CRT) display or a liquid crystal display; a communication line interface 2307 for connecting to a communication network, such as a network interface card; and a bus 2308 for connecting these devices so that data may be transmitted and received among the devices. Plural computers, each having the above-described configuration, may be connected to one another via a network.

In the above-described exemplary embodiment, the modules based on a computer program are realized by causing the system of this hardware configuration to read the computer program serving as software, and by causing software and hardware resources to cooperate with each other.

The hardware configuration illustrated in FIG. 23 is one example configuration. The exemplary embodiment is not limited to the configuration illustrated in FIG. 23, and another configuration may be used as long as the modules described above in the exemplary embodiment may be executed. For example, some of the modules may be configured by dedicated hardware (for example, an application specific integrated circuit (ASIC)), and some of the modules may be included in an external system and connected via a communication line. Furthermore, plural systems, each having the configuration illustrated in FIG. 23, may be connected to one another via a communication line and may operate in cooperation with one another. In particular, the system illustrated in FIG. 23 may be incorporated in an information appliance, a copier, a facsimile, a scanner, a printer, a multifunction peripheral (an image processing apparatus having any two or more of scanner, printer, copier, and facsimile functions), or the like, instead of the personal computer.

Alternatively, the above-described various processes may be combined (for example, the flowcharts illustrated in FIGS. 3, 11, 15, 16, and 19 may be combined). Also, a technique according to the related art may be adopted for a process performed by each module.

The above-described program may be provided by being stored in a recording medium, or may be provided via a communication unit. In that case, for example, the above-described program may be regarded as a “computer readable recording medium having the program recorded thereon”.

The “computer readable recording medium having the program recorded thereon” is a computer readable recording medium having the program recorded thereon, which is used for installing, executing, or circulating the program.

The following are examples of the recording medium: a DVD-R, a DVD-RW, a DVD-RAM, and the like, which are digital versatile discs (DVDs) and standards established by the DVD forum; a DVD+R, a DVD+RW, and the like, which are standards established by the DVD+RW; compact discs (CDs) such as a read only memory (CD-ROM), a CD recordable (CD-R), and a CD rewritable (CD-RW); a Blu-ray Disc (registered trademark); a magneto-optical (MO) disc; a flexible disk (FD); a magnetic tape; a hard disk; a read only memory (ROM); an electrically erasable, programmable read only memory (EEPROM, registered trademark); a flash memory; a random access memory (RAM); and a secure digital (SD) memory card.

The above-described program or a part of the program may be recorded on the recording medium and may be stored or circulated. Also, the program or a part of the program may be transmitted using a transmission medium, such as a wired network including a local area network (LAN), a metropolitan area network (MAN), a wide area network (WAN), the Internet, an intranet, and an extranet, or a wireless communication network, or a combination of the wired and wireless networks, or may be carried using a carrier.

Furthermore, the above-described program may be a part of another program, or may be recorded on a recording medium together with another program. Alternatively, the program may be recorded on plural recording media in a divided manner. The program may be recorded in any form as long as the program is recoverable, for example, the program may be compressed or encrypted.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an obtaining unit that obtains information regarding a first meeting;
a feature extracting unit that extracts a feature of the first meeting on the basis of the information regarding the first meeting;
a meeting extracting unit that extracts a second meeting on the basis of the feature of the first meeting, the second meeting having been registered;
a determining unit that determines whether or not the first meeting is continuous with the second meeting;
a registering unit that registers the first meeting and the second meeting as a group of continuous meetings if the determining unit determines that the first meeting is continuous with the second meeting;
a document extracting unit that extracts one or more documents associated with the group of the continuous meetings; and
a presenting unit that presents a list of the one or more documents extracted by the document extracting unit on the basis of a determination result by the determining unit.

2. The information processing apparatus according to claim 1, wherein the presenting unit determines a presentation order of the one or more documents in the list on the basis of the number of times each of the documents is associated with a meeting.

3. The information processing apparatus according to claim 1, further comprising:
a counting unit that counts the number of operations performed on the one or more documents presented by the presenting unit,
wherein the presenting unit determines a presentation order of the one or more documents in the list on the basis of the number of operations performed on each of the one or more documents, the number being counted by the counting unit.

4. The information processing apparatus according to claim 2, further comprising:
a counting unit that counts the number of operations performed on the one or more documents presented by the presenting unit,
wherein the presenting unit determines a presentation order of the one or more documents in the list on the basis of the number of operations performed on each of the one or more documents, the number being counted by the counting unit.

5. The information processing apparatus according to claim 1, wherein the presenting unit extracts a starting time of the first meeting from a memory which stores the starting time of the first meeting, compares the starting time with a current time, and determines whether or not the one or more documents extracted by the document extracting unit are to be presented.

6. The information processing apparatus according to claim 1, further comprising:
a meeting feature quantity extracting unit that extracts a meeting feature quantity, constructs a feature space, and generates a vector using the information regarding the first meeting in the feature space,
wherein the meeting extracting unit extracts the second meeting that has a similarity with respect to the first meeting when a distance between the vector and a vector for the second meeting is equal to or smaller than a predetermined value.

7. An information processing method comprising:
obtaining information regarding a first meeting;
extracting a feature of the first meeting on the basis of the information regarding the first meeting;
extracting a second meeting on the basis of the feature of the first meeting, the second meeting having been registered;
determining whether or not the first meeting is continuous with the second meeting;
registering the first meeting and the second meeting as a group of continuous meetings if the determining determines that the first meeting is continuous with the second meeting;
extracting one or more documents associated with the group of the continuous meetings; and
presenting a list of the extracted one or more documents on the basis of a determination result in the determining.

8. A computer readable medium storing an information processing program causing a computer to execute a process, the process comprising:
obtaining information regarding a first meeting;
extracting a feature of the first meeting on the basis of the information regarding the first meeting;
extracting a second meeting on the basis of the feature of the first meeting, the second meeting having been registered;
determining whether or not the first meeting is continuous with the second meeting;
registering the first meeting and the second meeting as a group of continuous meetings if the determining determines that the first meeting is continuous with the second meeting;
extracting one or more documents associated with the group of the continuous meetings; and
presenting a list of the extracted one or more documents on the basis of a determination result in the determining.
